(19) United States
(12) Patent Application Publication
(10) Pub. No.: US 2012/0049676 A1
(43) Pub. Date: Mar. 1, 2012

(54) Fluid dynamic bearing assembly and motor having the same

(75) Inventors: Ta Kyoung Lee, Hwaseong (KR); Young Tae Kim, Seoul (KR); Seung Woo Ha, Suwon (KR)

(73) Assignee: SAMSUNG ELECTRO-MECHANICS CO., LTD., Suwon (KR)

(21) Appl. No.: 12/929,043

(22) Filed: Dec. 23, 2010

(30) Foreign Application Priority Data
Aug. 25, 2010 (KR) 10-2010-0082669

(51) Int. Cl. F16C 32/06; H02K 7/08

(52) U.S. Cl. 310/90; 384/107

(57) ABSTRACT

There are provided a fluid dynamic bearing assembly and a motor having the same. The fluid dynamic bearing assembling according to the present invention may include: a sleeve formed to have a hollow into which a shaft is inserted; a sleeve housing formed to insert the sleeve therein; a bypass passage formed to axially communicate the upper portion and the lower portion of the sleeve between the sleeve and the sleeve housing dispersing pressure of a lubricating fluid in the hollow; and an oil sealing cap having an oil passage communicated with the bypass passage and taper-sealing the lubricating fluid within the oil passage.

### CROSS-REFERENCE TO RELATED APPLICATIONS

This application claims the priority of Korean Patent Application No. 10-2010-0082669 filed on Aug. 25, 2010, in the Korean Intellectual Property Office, the disclosure of which is incorporated herein by reference.

### BACKGROUND OF THE INVENTION

1. Field of the Invention

The present invention relates to a fluid dynamic bearing assembly and a motor having the same, and more particularly, to a fluid dynamic bearing motor capable of managing axial play of a fluid dynamic bearing assembly during an assembly thereof while saving manufacturing costs by simplifying a sleeve structure of the fluid dynamic bearing assembly and manufacturing components of a motor in a mold.

2. Description of the Related Art

Generally, a small spindle motor used in a recording disk driving apparatus uses a fluid dynamic bearing assembly, wherein the rotatably supports a shaft by filling a bearing clearance formed between the shaft and the sleeve of the fluid dynamic bearing assembly with a lubricating fluid, and forming fluid dynamic pressure while compressing oil filled in the bearing clearance when the shaft is rotated.

Further, a bypass passage is formed to penetrate through the sleeve supporting the shaft in an axial direction, thereby dispersing oil pressure generated by the compression of oil. The sleeve should be provided with the bypass passage and provided with parts for the fixing of other parts of the fluid dynamic bearing assembly. Therefore, in manufacturing the sleeve, a cylinder having a hollow is first manufactured and then, the bypass passage is formed by separate mechanical machining and parts for the fixing of other parts are machined.

Since the fluid dynamic bearing assembly is made by combining small parts, the mechanical machining of the sleeve must be performed very precisely. As a result, there is a problem in that the machining process is complex, machining time is long, and manufacturing costs are increased.

### SUMMARY OF THE INVENTION

An aspect of the present invention provides a fluid dynamic bearing assembly with improved productivity while saving manufacturing costs by simplifying a configuration of a sleeve, forming a pressure dispersion hole between an outer peripheral surface of the sleeve and a sleeve housing, and simplifying parts of a fluid dynamic bearing assembly to manufacture all parts in a mold, and a motor having the same.

Further, another aspect of the present invention provides a fluid dynamic bearing assembly capable of managing an axial play of a fluid dynamic bearing assembly during an assembly and a motor having the same.

According to an aspect of the present invention, there is provided a fluid dynamic bearing assembly, including: a sleeve formed to have a hollow into which a shaft is inserted; a sleeve housing formed to insert the sleeve therein; a bypass passage formed to axially communicate the upper portion and the lower portion of the sleeve between the sleeve and the sleeve housing and dispersing pressure of a lubricating fluid in the hollow; and an oil sealing cap having an oil passage communicated with the bypass passage and taper-sealing the lubricating fluid within the oil passage.

The oil sealing cap may be integrally formed with the sleeve housing.

The sleeve housing may be formed by performing press machining on a transparent plastic.

The fluid dynamic bearing assembly may further include a thrust plate formed to have a hole corresponding to a shape of the outer peripheral surface of the shaft and axially disposed under the sleeve.

A thrust bearing may be formed in a clearance between the upper surface of the thrust plate and the lower surface of the sleeve, a clearance between the outer peripheral surface of the thrust plate and the inner peripheral surface of the sleeve housing, and a clearance between the lower surface of the thrust plate and a sealing cover covering the lower portion of the sleeve.

The fluid dynamic bearing assembly may further include a thrust plate formed to have a hole corresponding to the shape of the outer peripheral surface of the shaft and disposed between the sleeve and the oil sealing cap.

A thrust bearing may be formed in a clearance between the upper surface of the thrust plate and the lower surface of the oil sealing cap, a clearance between the outer peripheral surface of the thrust plate and the inner peripheral surface of the sleeve housing, and a clearance between the lower surface of the thrust plate and the upper surface of the sleeve.

The sleeve may be formed by forging Cu or Al or sintering Cu—Fe-based alloy powder or SUS-based powder.

The lower surface of the sleeve housing may be provided with a step partially depressed to receive a curved portion formed at the outer peripheral portion of the sealing cover covering the lower portion of the sleeve.

The outer peripheral surface of the sleeve and the inner peripheral surface of the sleeve housing may be bonded to each other by an adhesive.

According to another aspect of the present invention, there is provided a fluid dynamic bearing assembly, including: a sleeve formed to have a hollow into which a shaft is inserted; a sealing cover covering the lower portion of the sleeve and the shaft and having a curved portion formed at the outer peripheral surface thereof; a sleeve housing formed to insert the sleeve therein and including a step depressed to receive the curved portion in the lower surface thereof; a bypass passage formed to axially communicate the upper portion and the lower portion of the sleeve between the sleeve and the sleeve housing and dispersing pressure of a lubricating fluid in the hollow; and an oil sealing cap having an oil passage communicated with the bypass passage and taper-sealing the lubricating fluid within the oil passage.

According to another aspect of the present invention, there is provided a fluid dynamic bearing assembly, including: a sleeve formed to have a hollow into which a shaft is inserted; a sleeve housing formed to insert the sleeve therein; a bypass passage formed to axially communicate the upper portion and the lower portion of the sleeve between the sleeve and the sleeve housing and dispersing pressure of a lubricating fluid in the hollow; and an oil sealing cap having an oil passage communicated with the bypass passage, formed so that the outer diameter thereof is larger than that of the sleeve, and taper-sealing the lubricating fluid within the oil passage, wherein the sleeve housing includes a step disposed at the outer side of the outer-diameter direction of the oil sealing cap and formed to receive a portion protruded from the outer peripheral surface of the sleeve in the oil sealing cap.

According to another aspect of the present invention, there is provided a fluid dynamic bearing assembly, including: a sleeve formed to have a hollow into which a shaft is inserted; a thrust plate formed to have a through hole into which the shaft is inserted, axially disposed over the sleeve, and formed so that the outer diameter thereof is larger than that of the sleeve; a sleeve housing formed to insert the sleeve therein; a bypass passage formed to axially communicate the upper portion and the lower portion of the sleeve between the sleeve and the sleeve housing and dispersing pressure of a lubricating fluid in the hollow; and an oil sealing cap having an oil passage communicated with the bypass passage, formed so that the outer diameter thereof is larger than that of the thrust plate, and taper-sealing the lubricating fluid within the oil passage, wherein the sleeve housing includes: a first seating portion disposed at the outer side of the outer-diameter direction of the thrust plate and formed to receive a portion protruded from the outer peripheral surface of the sleeve in the thrust plate; and a second seating portion disposed at the outer side of the outer-diameter direction of the oil sealing cap and formed to receive a portion protruded from the outer peripheral surface of the thrust plate in the oil sealing cap.

According to another aspect of the present invention, there is provided a motor, including: a fluid dynamic bearing assembly any one of the foregoing exemplary embodiments; a stator having a support portion to which the fluid dynamic bearing assembly is fixed; and a rotor having a magnet generating electromagnetic force by interaction with the coil of the stator.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of a motor according to a first exemplary embodiment of the present invention;

FIG. 2 is a partially enlarged cross-sectional view of part A of FIG. 1;

FIG. 3 is a cross-sectional view taken along line B-B′ of FIG. 1;

FIG. 4 is a perspective view showing a sleeve of a motor according to a first exemplary embodiment of the present invention;

FIG. 5 is a cross-sectional view of a motor according to a second exemplary embodiment of the present invention;

FIG. 6 is a cross-sectional view of a motor according to a third exemplary embodiment of the present invention;

FIG. 7 is a cross-sectional view of a motor according to a fourth exemplary embodiment of the present invention; and

FIG. 8 is a cross-sectional view of a motor according to a fifth exemplary embodiment of the present invention.

### DETAILED DESCRIPTION OF THE PREFERRED EMBODIMENT

Exemplary embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, and those are to be construed as being included in the spirit of the present invention.

Further, throughout the drawings, the same or similar reference numerals will be used to designate the same components or like components having the same functions in the scope of the similar idea.

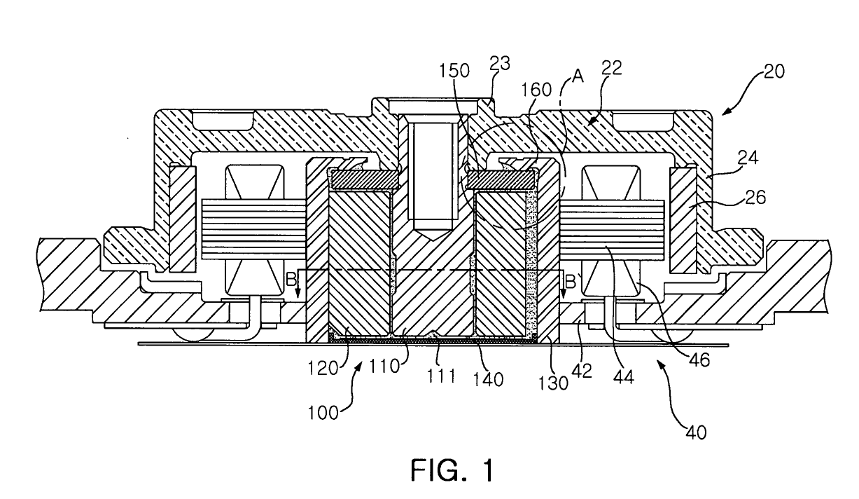

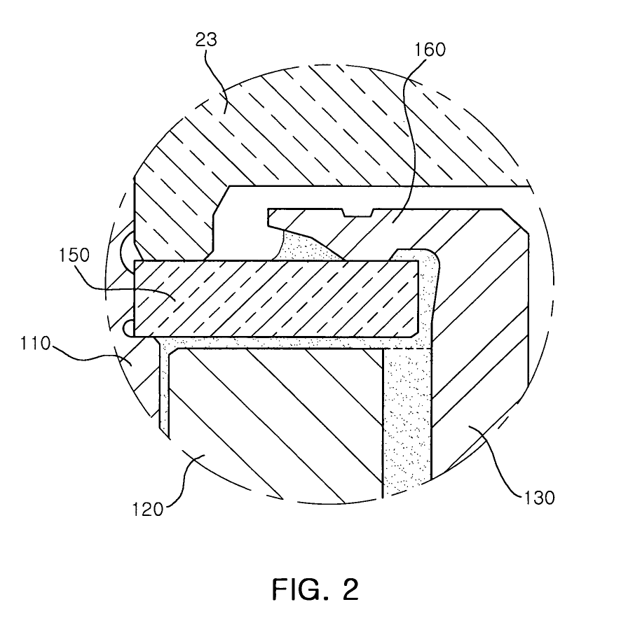

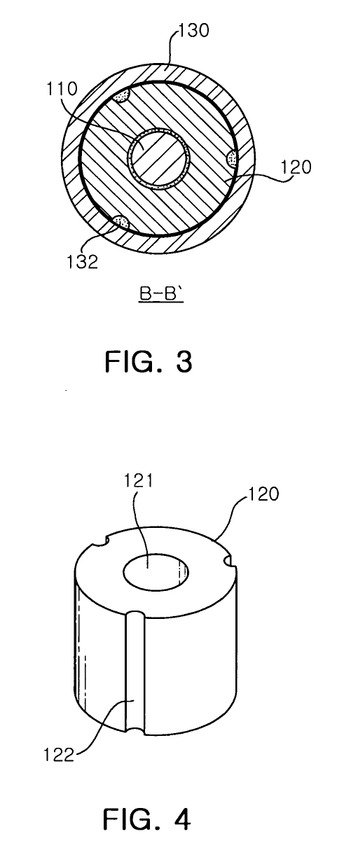

FIG. 1 is a cross-sectional view of a motor according to a first exemplary embodiment of the present invention, FIG. 2 is a partially enlarged cross-sectional view of part A of FIG. 1, FIG. 3 is a cross-sectional view taken along line B-B′ of FIG. 1, and FIG. 4 is a perspective view showing a sleeve of a motor according to a first exemplary embodiment of the present invention.

First, a configuration of a motor according to the present invention will be described with reference to FIG. 1.

As shown in FIG. 1, a motor according to the present invention may include a fluid dynamic bearing assembly 100, a stator 40, and a rotor 20.

The fluid dynamic bearing assembly 100 may be fixed to be disposed at an inner side of a support portion 42 of the stator 40 and may include a sleeve 120, a sleeve housing 130, or the like. Detailed exemplary embodiments of the fluid dynamic bearing assembly 100 will hereinafter be described. The motor according to the present invention may have all the characteristics of each exemplary embodiment of the fluid dynamic bearing assembly 100.

The rotor 20 includes a cup-shaped rotor case 22 whose outer peripheral portion is provided with an annular magnet 24 corresponding to a coil 46 of the stator 40. The magnet 24 is a permanent magnet generating a magnetic force of a predetermined strength by alternately magnetizing an N pole and an S pole thereof in a circumferential direction.

In this case, the rotor case 22 is configured to include a hub base 23 fixed while being press-fitted in an upper portion of a shaft 110 and a magnet support portion 24 supporting the magnet 24 of the rotor 20 by extending in an outer-diameter direction from the hub base 23 and being axially curved to the lower side thereof.

Meanwhile, terms in regards to directions are defined as follows. As viewed in FIG. 1, the axial direction refers to a vertical direction on the basis of the shaft 110, and the outer-diameter or inner-diameter direction refers to a direction of the outer end of the rotor 20 on the basis of the shaft 110 or a central direction of the shaft 110 on the basis of the outer end of the rotor 20.

The stator 40 includes a support portion 42 fixing the fluid dynamic bearing assembly 100 inserted thereinto, a plurality of cores 44, and a coil 46 surrounding the cores 44.

The rotor 20 is rotated by the electromagnetic interaction between the coil 46 and the magnet 24.

Hereinafter, each exemplary embodiment of the fluid dynamic bearing assembly according to the present invention will be described in detail.

Referring to FIGS. 1 to 4, the fluid dynamic bearing assembly 100 according to an exemplary embodiment of the present invention may include a shaft 110, a sleeve 120, a sleeve housing 130, a sealing cover 140, a thrust plate 150, and an oil sealing cap 160.

The shaft 110 is inserted into a hollow 121 formed at a central portion of the sleeve 120, the thrust plate 150 is disposed at the upper side of the axial direction of the sleeve 120, the oil sealing cap 160 is axially disposed over the thrust plate 150 to axially fix the thrust plate 150. The lower portion of the shaft 110 and the sleeve 120 are provided with the sealing cover 140 supporting the shaft 110 and the sleeve 120. The sleeve housing 130 covers the outer peripheral surfaces of the sleeve 120, the thrust plate 150, the oil sealing cap 160, and the sealing cover 140.

In this configuration, the shaft 110 is inserted while having a micro clearance with the hollow 121 of the sleeve 120. The micro clearance is filled with oil, which can more smoothly support the rotation of the rotor 20 due to the dynamic pressure generated by a radial bearing formed in at least one of the outer diameter of the shaft 110 and the inner diameter of the sleeve 120. In this case, the radial bearing may be supplied with oil from a reservoir 111. That is, the clearance between the sleeve 120 and the sealing cover 140 and the clearance between the sleeve 120 and the shaft 110 are communicated with each other and oil injected into each of these clearances may freely flow to be circulated therein.

The sealing cover 140 is made of an elastic material to be elastically deformed when jointed with the lower portion of a through hole formed in the sleeve housing 130 and covers the through hole of the sleeve housing 130 to support the sleeve 120 and the shaft 110. The sealing cover 140 may be jointed by contacting the outer circumferential surface thereof to the inner peripheral surface of the sleeve housing 130 and may jointed by contacting the curved portion formed to axially face the outer peripheral surface thereof to the inner peripheral surface of the sleeve housing 130. The clearance between the sealing cover 140 and the sleeve 120 is provided with a reservoir 111 receiving oil, such that the reservoir 111 itself may serve as a bearing supporting the lower surface of the shaft 110.

The sleeve 120 is provided with the hollow 121 to insert the shaft 110 into the central portion thereof and the outer peripheral surface of the sleeve 120 is provided with at least one groove 122 forming a connection between the upper portion and the lower portion of the sleeve 120. When the sleeve 120 is jointed with the sleeve housing 130, the upper portion and the lower portion of the sleeve 120 are formed to communicate with each other by the groove 122 and the inner peripheral surface of the sleeve housing 130, such that a bypass passage 132 for dispersing the pressure of a lubricating fluid in the hollow 121 of the sleeve 120 is formed.

The sleeve 120 may be formed by forging Cu or Al or sintering Cu—Fe-based alloy powder or SUS-based powder and may be similarly formed so that the outer diameter thereof is axially continued. Therefore, the sleeve 120 may be manufactured in one mold at the time of manufacturing the sleeve 120.

The sleeve housing 130 may be formed so that the sleeve 120 is inserted therein and may be similarly formed so that the inner diameter thereof is axially continued. Therefore, the sleeve housing 130 may be manufactured in one mold at the time of manufacturing the sleeve housing 130. The sleeve housing 130 may be formed by press-machining transparent plastic and the outer peripheral surface of the sleeve 120 and the inner peripheral surface of the sleeve housing 130 may be bonded to each other by an adhesive without being filled with a lubricating fluid.

The thrust plate 150 is axially disposed over the sleeve 120 and the centers thereof are provided with a hole corresponding to the cross section of the shaft 110 so that the shaft 110 is inserted into the hole. In this configuration, the thrust plate 150 may be manufactured separately to be jointed with the shaft 110, but may also be integrally formed with the shaft 110 from the beginning of manufacturing and may be rotated along the shaft 110 at the time of the rotary motion of the shaft 110. A first thrust bearing is interposed in a clearance between the thrust plate 150 and the sleeve 120.

The first thrust bearing, which is a fluid bearing, supports the thrust plate 150 and can reduce friction between the thrust plate 150 and the sleeve 120 at the time of the rotary motion of the thrust plate 150 such that the thrust plate 150 may continue to stably perform the rotary motion. The first thrust bearing may be formed by injecting oil into the clearance between the thrust plate 150 and the sleeve 120 and is connected with the above-mentioned radial bearing. That is, the clearance between the thrust plate 150 and the sleeve 120 and the clearance between the sleeve 120 and the shaft 110 are communicated with each other and oil injected into each of these clearances may freely flow to be circulated.

The oil sealing cap 160 is axially disposed over the thrust plate 150 and fixes the thrust plate 150 in an axial direction. Further, the lower surface of the oil sealing cap 160 may be formed to have a protruding portion to seal the passage of the lubricating fluid. The oil sealing cap 160 has an oil passage communicating with the bypass passage 132 and may be configured to taper-seal the lubricating fluid in the oil passage. The oil sealing cap 160 may be formed as a separate member from the sleeve housing 130. In the first exemplary embodiment, the oil sealing cap 160 may be integrally formed with the sleeve housing 130. The second thrust bearing may be formed in the clearance formed by the oil sealing cap 160, the thrust plate 150, and the sleeve housing 130.

The second thrust bearing, which is a fluid bearing, may be formed by injecting oil into the clearance formed between the outer peripheral surface of the thrust plate 150 and the inner peripheral surface of the sleeve housing 130 and between a portion of the upper surface of the thrust plate 150 and a portion of the lower surface of the oil sealing cap 160 and may reduce friction between the thrust plate 150 and the sleeve housing 130 and between the thrust plate 150 and the oil sealing cap 160 at the time of the rotary motion of the thrust plate 150 such that the thrust plate 150 can continue to stably perform the rotary motion.

Further, the third thrust bearing may be formed by the oil passage in the clearance between the upper surface of the thrust plate 150 and the lower surface of the oil sealing cap 160.

In addition, the second and third thrust bearings are connected to the first thrust bearing. That is, the clearance between the thrust plate 150 and the sleeve 120 and the clearance between the thrust plate 150, the oil sealing cap 160, and the sleeve housing 130 are communicated with each other and oil injected into each of these clearances may freely flow therebetween to be circulated.

Meanwhile, the bypass passage 132 formed by the groove 122 of the sleeve 120 and the inner peripheral surface of the sleeve housing 130 connects the first and second thrust bearing with the reservoir 111 to smoothly circulate the oil filled in the first and second thrust bearings and the oil filled in the reservoir 111 through the bypass passage 132, thereby making it possible to uniformly disperse the pressure applied to each fluid bearing in the fluid dynamic bearing assembly and move bubbles, or the like, existing in the fluid dynamic bearing assembly to be discharged by circulation.

Although the first exemplary embodiment describes that oil is filled in the radial bearing, the first and second thrust bearings, and the reservoir, it may be variously changed according to the demand of a design.

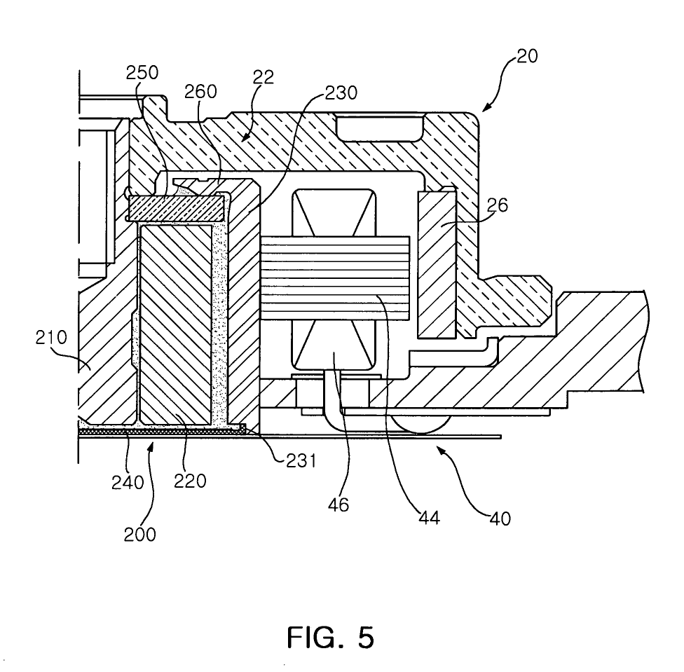

FIG. 5 is a cross-sectional view of a motor according to a second exemplary embodiment of the present invention. In a motor according to a second exemplary embodiment of the present invention shown in FIG. 5, a modified example of the joint of the sleeve housing and the sealing cover is shown. Other components are substantially the same as the motor according to the first exemplary embodiment of the present invention shown in FIGS. 1 to 4 and therefore, a detailed description of the components thereof will be omitted. Hereinafter, only the differences therebetween will be described.

Referring to FIG. 5, in the motor according to the second exemplary embodiment of the present invention, the fluid dynamic bearing assembly 200 may include a sleeve 220 into which a shaft 210 is inserted, a sealing cover 240 covering the lower portions of the sleeve 220 and the shaft 210, a sleeve housing 230 formed so as to insert the sleeve 220 therein, and an oil sealing cap 260 taper-sealing a lubricating fluid. In this configuration, the sleeve housing 230 and the oil sealing cap 260 may be manufactured separately and may be integrally formed. The bypass passage is formed between the sleeve 220 and the sleeve housing 230.

The sleeve 220 is similarly formed so that the outer diameter thereof is axially continued and the outer peripheral surface of the sealing cover 240 is formed to have a curved portion, wherein the curved portion may be received in a step 231 formed by being depressed in the lower surface of the sleeve housing 230.

In the second exemplary embodiment, the sleeve housing 230 is provided with the step 231 jointed with the sealing cover 240, such that the sleeve housing 230 and the sealing cover 240 can be more firmly jointed.

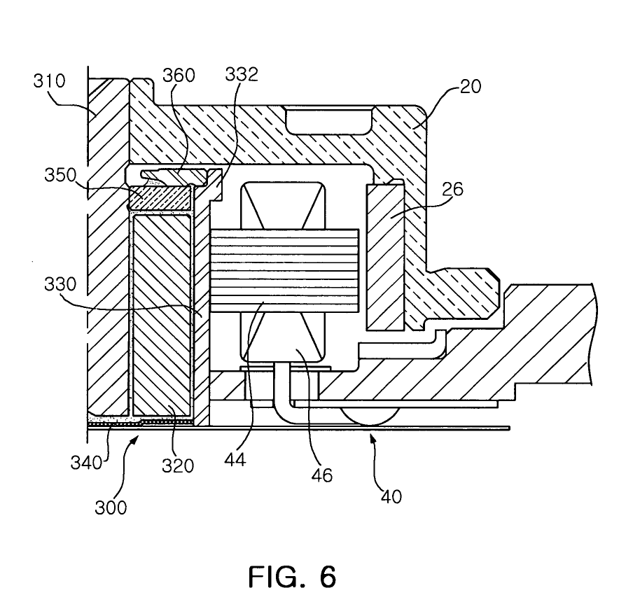

FIG. 6 is a cross-sectional view of a motor according to a third exemplary embodiment of the present invention. A motor according to a third exemplary embodiment of the present invention shown in FIG. 6 is a modified example of the first exemplary embodiment of the present invention in that it is disposed outer side of the oil sealing cap in an outer-diameter direction and a step formed to receive a portion protruded from the outer peripheral surface of the sleeve in the oil sealing cap is formed in the sleeve housing. Other components are substantially the same as the fluid dynamic bearing assembly of the motor according to the first exemplary embodiment of the present invention shown in FIGS. 1 to 4 and therefore, a detailed description of the components thereof will be omitted. Hereinafter, only the differences therebetween will be described.

Referring to FIG. 6, in the motor according to the third exemplary embodiment of the present invention, the fluid dynamic bearing assembly 300 may include a sleeve 320 into which a shaft 310 is inserted, a sealing cover 340 covering the lower portions of the sleeve 320 and the shaft 310, a sleeve housing 330 formed so as to insert the sleeve 320 therein, and an oil sealing cap 360 taper-sealing a lubricating fluid. In this configuration, the sleeve 320 may be similarly formed so that the outer diameter thereof is axially continued. The bypass passage is formed between the sleeve 320 and the sleeve housing 330.

The outer diameter of the oil sealing cap 360 is formed to be larger than that of the sleeve 320 and the sleeve housing 330 is disposed at the outer side of the outer-diameter direction of the oil sealing cap 360 and may include a step 332 formed to receive a portion protruded from the outer peripheral surface of the sleeve 320 in the oil sealing cap 360. In this case, the sleeve housing 330 is manufactured by performing the press machining on a plate material, thereby making it possible to easily form the step 332.

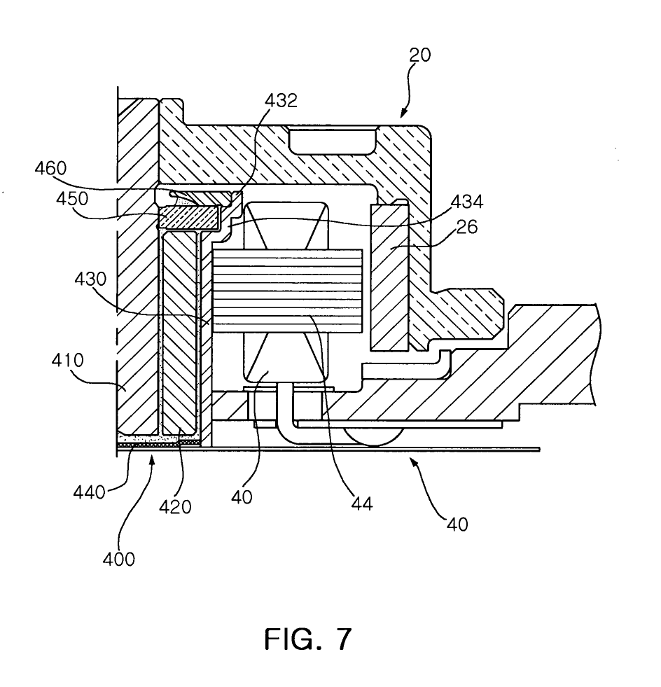

FIG. 7 is a cross-sectional view of a motor according to a fourth exemplary embodiment of the present invention. A motor according to a fourth exemplary embodiment of the present invention shown in FIG. 7 is a modified example of the third exemplary embodiment of the present invention in that the sleeve housing includes a seating portion provided at an outer side of the outer-diameter direction of the oil sealing cap and at an outer side of the outer-diameter direction of the thrust plate, respectively. Other components are substantially the same as the motor according to the third exemplary embodiment of the present invention shown in FIG. 6 and therefore, a detailed description of the components thereof will be omitted. Hereinafter, only the differences therebetween will be described.

Referring to FIG. 7, the fluid dynamic bearing assembly 400 of the motor according to the fourth exemplary embodiment of the present invention may include a through hole into which a shaft 410 is inserted, a thrust plate 450 axially disposed over the sleeve 420, a thrust plate 450 formed so that the outer diameter thereof is larger than that of the sleeve 420, and an oil sealing cap 460 disposed over the thrust plate 450 and formed so that the outer diameter thereof is larger than that of the thrust plate 450. In this configuration, the bypass passage is formed between the sleeve 420 and the sleeve housing 430.

The sleeve housing 430 may include a first seating portion 434 disposed at the outer side of the outer-diameter direction of the thrust plate 450 and formed to receive a portion protruded from the outer peripheral surface of the sleeve 420 in the thrust plate 450 and a second seating portion 432 disposed at an outer side of the outer-diameter direction of the oil sealing cap 460 and formed to receive a portion protruded from the outer peripheral surface of the thrust plate 450 of the oil sealing cap 460.

In the fourth exemplary embodiment, the sleeve housing 430 is manufactured by performing the press machining on a plate material, thereby making it possible to easily form the first seating portion 434 and the second seating portion 432.

As described above, in the case of the fluid dynamic bearing assembly according to the third and fourth exemplary embodiments of the present invention, the step of the sleeve housing supporting the thrust plate and the oil sealing cap may be formed by performing the press machining on the first and second seating portions, such that the thrust plate and the oil sealing cap can be firmly supported with a simple structure.

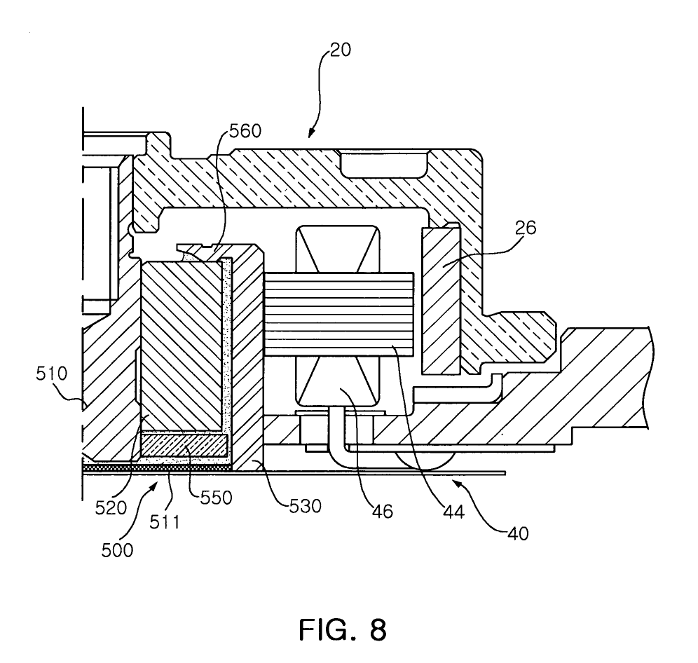

FIG. 8 is a cross-sectional view of a motor according to a fifth exemplary embodiment of the present invention. A motor according to a fifth exemplary embodiment of the present invention shown in FIG. 8 is different from the first exemplary embodiment in that the thrust plate is axially disposed under the shaft and therefore, other components will mainly be described.

Referring to FIG. 8, a fluid dynamic bearing assembly 500 of the motor according to the fifth exemplary embodiment of the present invention includes a thrust plate 550 formed to have a through hole into which a shaft 510 is inserted and axially disposed under the sleeve 520, wherein the sleeve 520 may be axially disposed over the thrust plate 550 and the oil sealing cap 560 may be axially disposed over the sleeve 520. In this configuration, the bypass passage may be formed between the sleeve 520 and the sleeve housing 530.

The thrust bearing may be formed by injecting the lubricating fluid such as oil into the clearance between the upper surface of the thrust plate 550 and the lower surface of the sleeve 520, the clearance between the outer peripheral surface of the thrust plate 550 and the inner peripheral surface of the sleeve housing 530, and the clearance between the lower surface of the thrust plate 550 and the sealing cover 540 covering the lower portion of the sleeve 520.

The thrust bearing, which is a fluid bearing, supports the thrust plate 550 and can reduce friction between the thrust plate 550 and the sleeve 520, between the thrust plate 550 and the sleeve housing 530, and between the thrust plate 550 and the sealing cover 540 at the time of the rotary motion of the thrust plate 550, such that the thrust plate continues to stably perform the rotary motion. The thrust bearing is connected to the above-mentioned radial bearing. That is, the clearance between the thrust plate 550 and the sleeve 520 and the clearance between the sleeve 520 and the shaft 510 are communicated with each other and oil injected into each of these clearances may freely flow to be circulated.

As set forth above, according to the fluid dynamic bearing assembly and the motor having the same, all the parts can be manufactured in a mold by simplifying the configuration of the sleeve, forming the bypass passage dispersing the pressure on the outer peripheral surface of the sleeve, and simplifying parts of the fluid dynamic bearing assembly including the sleeve, thereby making it possible to save on manufacturing costs and improve productivity.

Further, the present invention can manage the axial play of the fluid dynamic bearing assembly during the assembly.

While the present invention has been shown and described in connection with the exemplary embodiments, it will be apparent to those skilled in the art that modifications and variations can be made without departing from the spirit and scope of the invention as defined by the appended claims.

What is claimed is:

1. A fluid dynamic bearing assembly, comprising:
a sleeve formed to have a hollow into which a shaft is inserted;
a sleeve housing formed to insert the sleeve therein;
a bypass passage formed to axially communicate the upper portion and the lower portion of the sleeve between the sleeve and the sleeve housing and dispersing pressure of a lubricating fluid in the hollow; and
an oil sealing cap having an oil passage communicated with the bypass passage and taper-sealing the lubricating fluid within the oil passage.

2. The fluid dynamic bearing assembly of claim 1, wherein the oil sealing cap is integrally formed with the sleeve housing.

3. The fluid dynamic bearing assembly of claim 1, wherein the sleeve housing is formed by performing press machining on a transparent plastic.

4. The fluid dynamic bearing assembly of claim 1, further comprising a thrust plate formed to have a hole corresponding to a shape of the outer peripheral surface of the shaft and axially disposed under the sleeve.

5. The fluid dynamic bearing assembly of claim 4, wherein a thrust bearing is formed in a clearance between the upper surface of the thrust plate and the lower surface of the sleeve, a clearance between the outer peripheral surface of the thrust plate and the inner peripheral surface of the sleeve housing, and a clearance between the lower surface of the thrust plate and a sealing cover covering the lower portion of the sleeve.

6. The fluid dynamic bearing assembly of claim 1, further comprising a thrust plate formed to have a hole corresponding to the shape of the outer peripheral surface of the shaft and disposed between the sleeve and the oil sealing cap.

7. The fluid dynamic bearing assembly of claim 6, wherein a thrust bearing is formed in a clearance between the upper surface of the thrust plate and the lower surface of the oil sealing cap, a clearance between the outer peripheral surface of the thrust plate and the inner peripheral surface of the sleeve housing, and a clearance between the lower surface of the thrust plate and the upper surface of the sleeve.

8. The fluid dynamic bearing assembly of claim 1, wherein the sleeve is formed by forging Cu or Al or sintering Cu—Fe-based alloy powder or SUS-based powder.

9. The fluid dynamic bearing assembly of claim 1, wherein the outer peripheral surface of the sleeve and the inner peripheral surface of the sleeve housing are bonded to each other by an adhesive.

10. A fluid dynamic bearing assembly, comprising:
a sleeve formed to have a hollow into which a shaft is inserted;
a sealing cover covering the lower portions of the sleeve and the shaft and having a curved portion formed at the outer peripheral surface thereof;
a sleeve housing formed to insert the sleeve therein and including a step depressed to receive the curved portion in the lower surface thereof;
a bypass passage formed to axially communicate the upper portion and the lower portion of the sleeve between the sleeve and the sleeve housing and dispersing pressure of a lubricating fluid in the hollow; and
an oil sealing cap having an oil passage communicated with the bypass passage and taper-sealing the lubricating fluid within the oil passage.

11. A fluid dynamic bearing assembly, comprising:
a sleeve formed to have a hollow into which a shaft is inserted;
a sleeve housing formed to insert the sleeve therein;
a bypass passage formed to axially communicate the upper portion and the lower portion of the sleeve between the sleeve and the sleeve housing and dispersing pressure of a lubricating fluid in the hollow; and
an oil sealing cap having an oil passage communicated with the bypass passage, formed so that the outer diameter thereof is larger than that of the sleeve, and taper-sealing the lubricating fluid within the oil passage,
wherein the sleeve housing includes a step disposed at the outer side of the outer-diameter direction of the oil sealing cap and formed to receive a portion protruded from the outer peripheral surface of the sleeve in the oil sealing cap.

12. A fluid dynamic bearing assembly, comprising:
a sleeve formed to have a hollow into which a shaft is inserted;
a thrust plate formed to have a through hole into which the shaft is inserted, axially disposed over the sleeve, and formed so that the outer diameter thereof is larger than that of the sleeve;
a sleeve housing formed to insert the sleeve therein;
a bypass passage formed to axially communicate the upper portion and the lower portion of the sleeve between the sleeve and the sleeve housing and dispersing pressure of a lubricating fluid in the hollow; and
an oil sealing cap having an oil passage communicated with the bypass passage, formed so that the outer diameter thereof is larger than that of the thrust plate, and taper-sealing the lubricating fluid within the oil passage,
wherein the sleeve housing includes:
a first seating portion disposed at the outer side of the outer-diameter direction of the thrust plate and formed to receive a portion protruded from the outer peripheral surface of the sleeve in the thrust plate; and
a second seating portion disposed at the outer side of the outer-diameter direction of the oil sealing cap and formed to receive a portion protruded from the outer peripheral surface of the thrust plate in the oil sealing cap.

13. A motor, comprising:
a fluid dynamic bearing assembly supporting a shaft claimed in any one of claim 1:
a stator having a support portion to which the fluid dynamic bearing assembly is fixed; and
a rotor having a magnet generating electromagnetic force by interaction with the coil of the stator.

14. A motor, comprising:
a fluid dynamic bearing assembly supporting a shaft claimed in any one of claim 11:
a stator having a support portion to which the fluid dynamic bearing assembly is fixed; and
a rotor having a magnet generating electromagnetic force by interaction with the coil of the stator.

15. A motor, comprising:
a fluid dynamic bearing assembly supporting a shaft claimed in any one of claim 12:
a stator having a support portion to which the fluid dynamic bearing assembly is fixed; and
a rotor having a magnet generating electromagnetic force by interaction with the coil of the stator.
